(19) United States
(12) Patent Application Publication
(10) Pub. No.: US 2018/0286123 A1
(43) Pub. Date: Oct. 4, 2018

(54) 3D Printing and Tagging

(71) Applicant: SPAWAR Systems Center Pacific, San Diego, CA (US)

(72) Inventors: Heidi L. Buck, San Diego, CA (US); Arne T. Odland, San Diego, CA (US); Joshua S. Li, San Diego, CA (US); Larry C. Greunke, Lakeside, CA (US); David G. Rousseau, San Diego, CA (US)

(73) Assignee: United States of America as represented by Secretary of the Navy, San Diego, CA (US)

(21) Appl. No.: 15/473,969

(22) Filed: Mar. 30, 2017

(51) Int. Cl. G06T 19/00; G06F 3/01; G06T 7/70; G09B 9/00

(52) U.S. Cl. CPC G06T 19/006; G06F 3/011; G09B 9/003; G09B 9/00; G06T 7/70

(57) ABSTRACT

A system is provided that includes a 3-dimensional object, a tagging element, a tracking system and an imaging system. The tagging element is disposed at a tagging element position of the 3-dimensional object so as to correspond with an object position of the 3-dimensional object. The tracking system detects the tagging element position and orientation and outputs a tagging element detected signal based on the detected tagging element position and orientation. The imaging system generates an object image based on the tagging element detected signal. The object image corresponds to the 3-dimensional object at a generated object position and orientation corresponding to the object position and orientation.

The United States Government has ownership rights in this invention. Licensing inquiries may be directed to Office of Research and Technical Applications, Space and Naval Warfare Systems Center, Pacific, Code 3600, San Diego, Calif., 92152; telephone (619)553-5118; email: ssc_pac_t2@navy.mil. Reference Navy Case No. 104,217.

### BACKGROUND OF THE INVENTION

Embodiments of the invention relate to a system and method for creating virtual training devices with physical counterparts.

Current methods for training individuals to perform operational or maintenance tasks that require physical manipulation of a device can vary significantly. One way to provide training is to use documents, briefings, or lectures to show an individual how to perform the required tasks. Another way to provide training is to show the trainee how to perform the tasks with on-the-job training. Training can also be provided by using a fully functioning version of the actual system to be used.

There exists a need for a low cost training system and method where the relationship between the training display and training console is dynamically updated to prevent training errors.

### SUMMARY OF THE INVENTION

An aspect of the present invention is drawn to a system that includes a 3-dimensional object, a tagging element, a tracking system and an imaging system. The tagging element is disposed at a tagging element position of the 3-dimensional object so as to correspond with an object position of the 3-dimensional object. The tracking system detects the tagging element position and outputs a tagging element detected signal based on the detected tagging element position. The imaging system generates an object image based on the tagging element detected signal. The object image corresponds to the 3-dimensional object at a generated object position corresponding to the object position.

### BRIEF DESCRIPTION OF THE DRAWINGS

The accompanying drawings, which are incorporated in and form a part of the specification, illustrate example embodiments and, together with the description, serve to explain the principles of the invention. In the drawings:

FIG. 1 illustrates a conventional training system with a fully functioning version of the actual system;

FIGS. 2A-2B illustrate a conventional training system that incorporates virtual reality;

FIG. 3 illustrates a method in accordance with aspects of the present invention;

FIGS. 4A-4C illustrate embodiments of a training console in accordance with aspects of the present invention; and

FIG. 5 illustrates a training system in accordance with aspects of the present invention.

### DETAILED DESCRIPTION OF THE EMBODIMENTS

The present invention provides a system and method for creating virtual training devices with physical counterparts.

Embodiments of the invention provide for creating a training console that is similar to an actual console in size, shape, and position of user controls. Virtual reality goggles can communicate with the training console and dynamically update the view provided to the trainee wearing the goggles based on one or more tagging elements disposed on, or in, the training console. Therefore, there is never a mismatch between the virtual location and physical location of the training console or its associated controls, resulting in a more effective training experience.

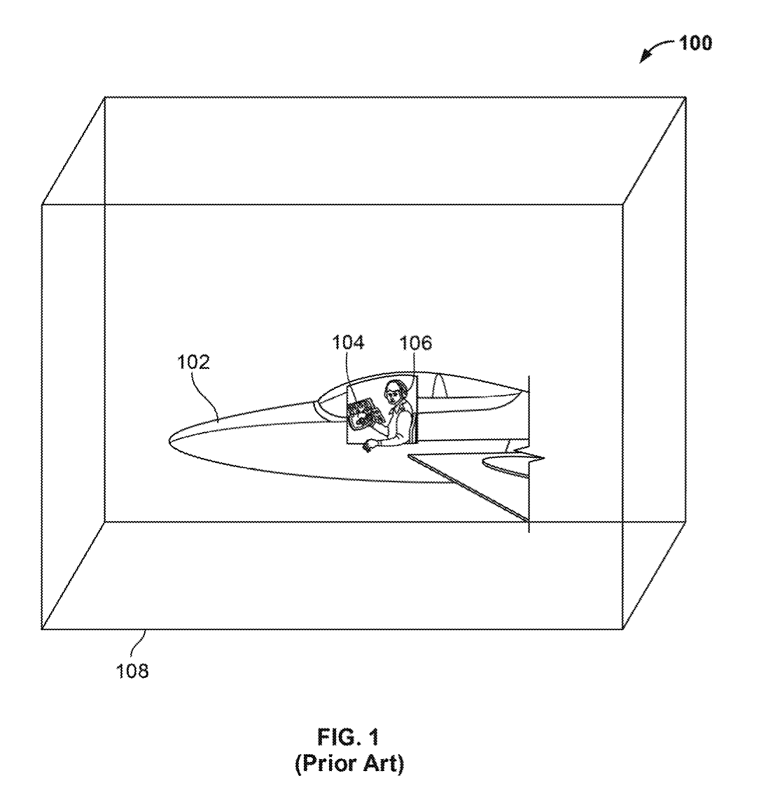

FIG. 1 illustrates a conventional training system with a fully functioning version of the actual system.

As shown in the figure, system 100 includes a training room 108, a cockpit replica 102, a control replica 104, and a trainee 106.

Cockpit replica 102 is an exact replica of an actual cockpit that trainee 106 will eventually use. Control replica 104 is also an exact replica of the actual controls that trainee 106 will eventually use. In order to immerse the trainee in a simulated environment, though, what trainee 106 sees must make it seem like trainee 106 is actually flying a plane. Therefore, any windows providing an outside view must be replaced with live display panels to simulate the view from a non-training environment. In addition, the controls, e.g, buttons, levers, switches, knobs, valves, etc., on control replica 104 must be in communication with the live display panels because the display panels must update the view in accordance with how trainee 106 manipulates the buttons on control replica 104.

It should be noted that, in some cases, the controls on control replica 102 may also change the information displayed on the control panel, and even change the way other buttons look and function. For example, pressing a button on a multi-function display (MFD) on control replica 102, not only changes what is displayed on the MFD screen, it may also change all the digital labels on all the other buttons on the MFD.

The example using cockpit replica 102 was used for purposes of description and explanation, but similar devices could be used in various functions and industries. Some examples include air traffic control, big-rig trucking, and boat or submarine control. Creating full-sized, working replicas of expensive equipment does not make economic sense, so there have been some attempts to decrease training costs by simplifying the training environment.

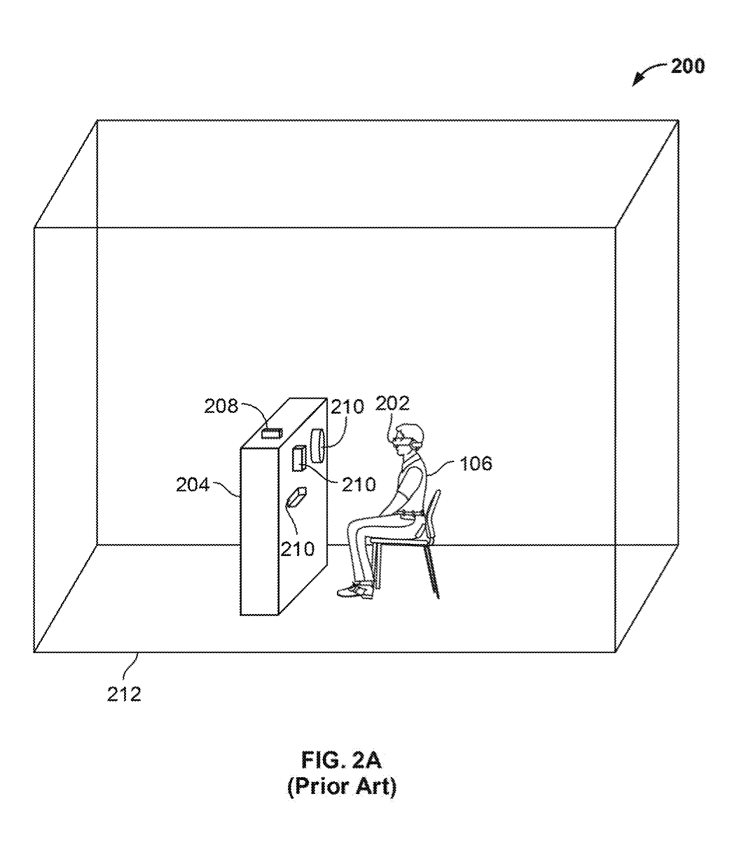

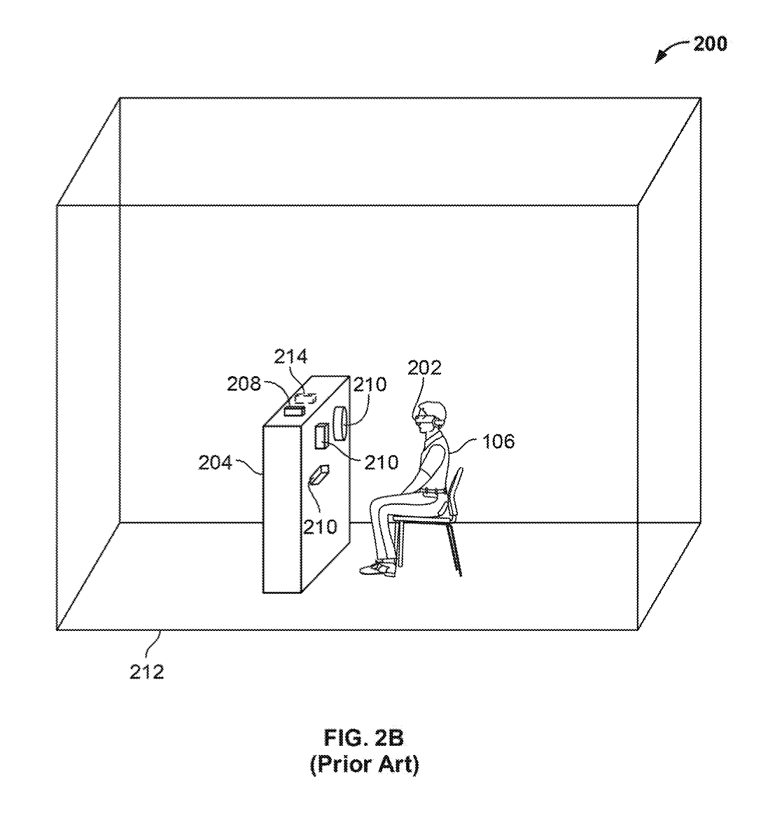

FIGS. 2A-B illustrate a conventional training system that incorporates virtual reality.

As shown in the figures, system 200 includes trainee 106, a training room 212, a set of virtual reality goggles 202, a training console 204, a target button 208, a plurality of buttons 210, and a ghost target button 214. The difference between FIG. 2A and FIG. 2B is that ghost target button 214 is included in FIG. 2B and not in FIG. 2A.

Referring to FIG. 2A, training room 212 is set up in a specific way, with training console 204 in a certain location relative to the position of trainee 106. Training console 204 is not a fully functioning replica of the actual console trainee 106 will eventually use. The size and shape of training console 204 is similar to that of the actual console, however it can be made from less expensive materials. In addition, plurality of buttons 210 and target button 208 are functioning buttons in that they can move when pushed or manipulated by trainee 106, but plurality of buttons 210 and target button 208 are not exact replicas of the buttons trainee 106 will actually use.

Trainee 106 wears virtual reality goggles 202, which provide trainee 106 an immersive display that allows trainee 106 to feel as though he is in another location for training. Plurality of buttons 210 and target button 208 are in communication with virtual reality goggles 202 such that the display on virtual reality goggles 202 changes when trainee 106 manipulates plurality of buttons 210 or target button 208.

Virtual reality goggles 202 may include traditional types of virtual reality goggles that fully immerse the user in a virtual environment, but virtual reality goggles 202 may also include augmented reality goggles, or mixed reality goggles, depending on how the training room or training system is designed.

In system 200, virtual reality goggles 202 are programmed for a specific view from a specific location. When trainee 106 sits down in front of training console 204 and puts on virtual reality goggles 202, trainee 106 sees an image of the actual console that coincides with training console 204, and buttons that coincide with plurality of buttons 210 and target button 208. Problems may arise, though, if the position of trainee 106 changes. If the position of trainee 106 moves slightly to the side from the intended position, the images of the actual console may not coincide with the physical items in front of trainee 106. This will be described below with reference to FIG. 2B.

For example, and with reference to FIG. 2B, trainee 106 may desire to press target button 208 during the training session. In a successful training session, virtual reality goggles 202 display ghost button 214 in the view of trainee 106 that directly coincides with the physical location of target button 208. However, if trainee 106 changes position slightly, ghost button 214 may not directly coincide with the physical location of target button 208. In such an instance, trainee 106 will attempt to press target button 208 by moving his finger to the location of ghost button 214, and trainee 106 will not actually press target button 208. The training session is then a failure.

A system for and method of creating a device and corresponding virtual image of the device eliminates problems of virtual or augmented training systems discussed above.

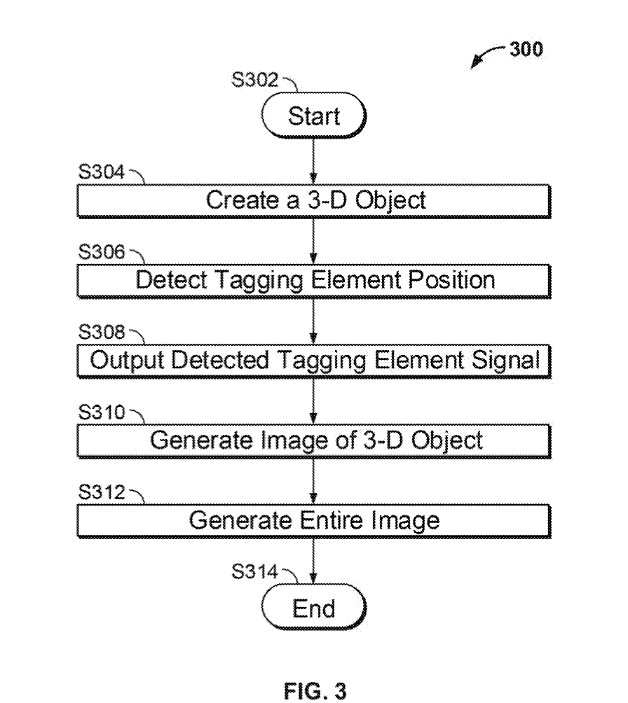

Aspects of the present invention will now be described with reference to FIGS. 3-5.

FIG. 3 illustrates a method 300 of creating a device and corresponding virtual image of the device in accordance with aspects of the present invention.

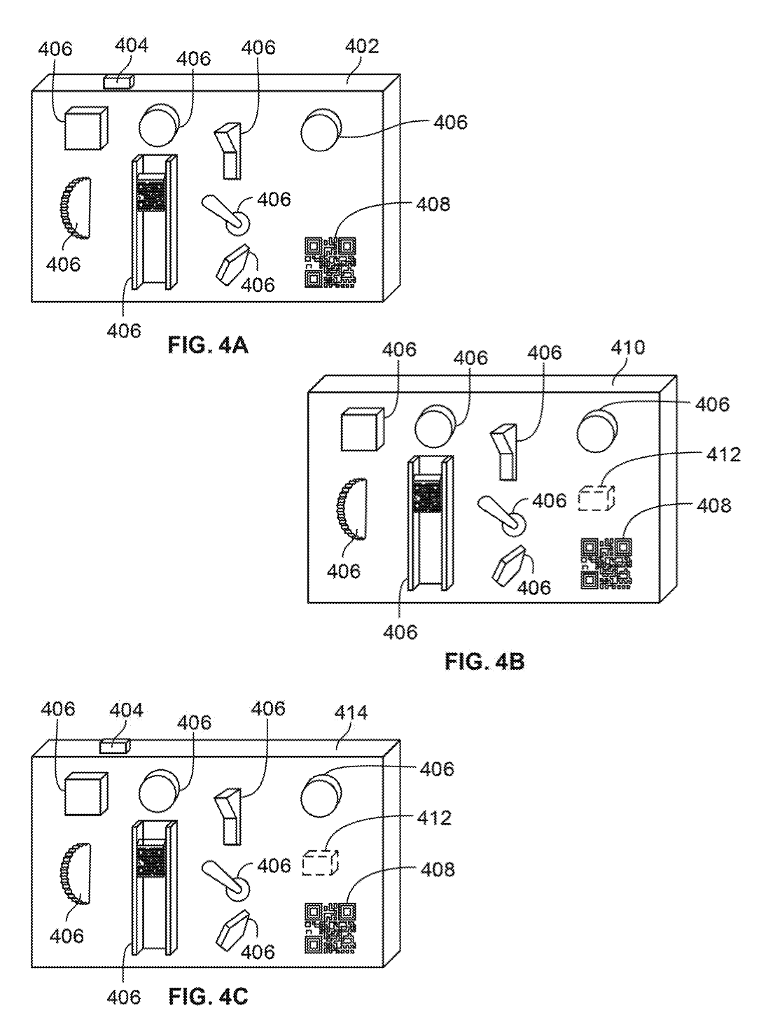

As shown in the figure, method 300 starts (S302) and a 3-dimensional (3-D) object is created (S304). This will be further described with additional reference to FIGS. 4A-4C.

FIGS. 4A-4C illustrate embodiments of an example training console in accordance with aspects of the present invention.

As shown in FIG. 4A, training console 402 includes a tagging element 404 disposed at training console 402, console controls 406, and a verification element 408. In this example embodiment, tagging element 404 is disposed on training console 402. However, in other embodiments, a tagging element may be disposed within a training console. This will be described with reference to FIG. 4B.

As shown in FIG. 4B, training console 410 includes a tagging element 412 disposed within training console 412. In the embodiments of FIGS. 4A-B, a single tagging element is disposed at the training console. However, in other embodiments, a plurality of tagging elements may be disposed at a training console. This will be described with reference to FIG. 4C.

As shown in FIG. 4C, training console 414 includes tagging element 404 disposed on top of training console 414 and tagging element 412 disposed within training console 414.

For purposes of discussion and brevity, creation of a training console will be described with respect to training console 414, with the understanding that the description of the creation of training console 414 is applicable to training consoles 402 and 410 as well.

Training console 414 is created to replicate the size and shape of the actual console a trainee will eventually encounter. For purposes of explanation, suppose the trainee is training to be a landing signal officer on an aircraft carrier. The console a landing signal officer must operate is complex and has many different controls that must be manipulated properly to communicate with aircraft attempting to land. Instead of creating a fully functional replica of the actual console, training console 414 can be created to aid training exercises.

In one embodiment, training console 414 can be manufactured using a 3-D printer. 3-D printers are capable of creating structures with movable elements that can be manipulated, like console controls 406, such that a single printing session can create a working training console 414. A 3-D printed version of training console 414 may incorporate materials such as nylon, polyamide, ABS, PLA, stainless steel, or titanium. In other embodiments, console controls 406 may be printed with materials different from the rest of training console 414 to create a different feel for the trainee. In yet other embodiments, some of console controls 406 may be printed with materials different from other of console controls 406 to mimic differences in button materials on actual consoles.

In another embodiment, training console 414 can be manufactured using manufacturing processes such as injection molding, metal stamping or forging, or machining. Any plastic or metal material suitable for the appropriate manufacturing method can be used.

Console controls 406 are designed to operate like the buttons on an actual console, and console controls 406 may include a variety of elements a trainee can manipulate. Examples of console controls 406 include, but are not limited to, push buttons, sliders, rotating dials, wheels, or any other type of element that would mimic the operation of a manupulable element on an actual console.

Tagging elements 404 and 412 allow a virtual reality system to determine the position and/or orientation of training console 414. “Position,” as used herein, corresponds to a geographic location, e.g., an x,y,z coordinate location. On the other hand, “orientation,” as used herein, corresponds to a three dimensional angular attitude within the geographic location, e.g., a roll,pitch,yaw angular attitude.

Tagging element 404 is disposed on the outer surface of training console 414. Tagging element 412 is disposed within training console 414. Tagging elements 404 and 412 may be any device or system that can communicate, either wirelessly or in a wired manner, with a virtual reality system, non-limiting examples of which include optical sensors or cameras, radiofrequency transmitters, GPS devices, or any other type of device that can provide a virtual reality system position and/or orientation information.

Tagging element 404 may be secured to training console 414 by any known method or mechanism that would prevent tagging element 404 from moving during a training session including. Non-limiting examples of such securing methods and mechanisms include adhesives and mechanical fasteners.

Tagging element 412 may be embedded within training console 414 in various ways depending on how training console 414 is manufactured. In one embodiment, tagging element 412 may be placed within a 3-D printer such that the printing material is disposed around tagging element 412 until tagging element 412 is embedded within training console 414. In another embodiment, tagging element 412 may be included in an injection molding process such that, during the injection molding process the molten plastic flows around tagging element 412, embedding tagging element 412 within training console 414. In yet another embodiment, training console 414 may be constructed in two or more pieces, and tagging element may be disposed within training console 414 when the two or more pieces are assembled together.

Verification element 408 is disposed on the surface of training console 414 and provides information to a virtual reality system that the virtual reality system uses to display the appropriate images to the trainee. Verification element 408 may be any type of visual identifier that can be read optically, non-limiting examples of which include bar codes, QR codes, and 3-D bar codes. In one embodiment, verification element 408 may be printed integrally with training console 414 during the 3-D printing process. In another embodiment, verification element 408 may be a sticker or other device that can be attached to training console 414.

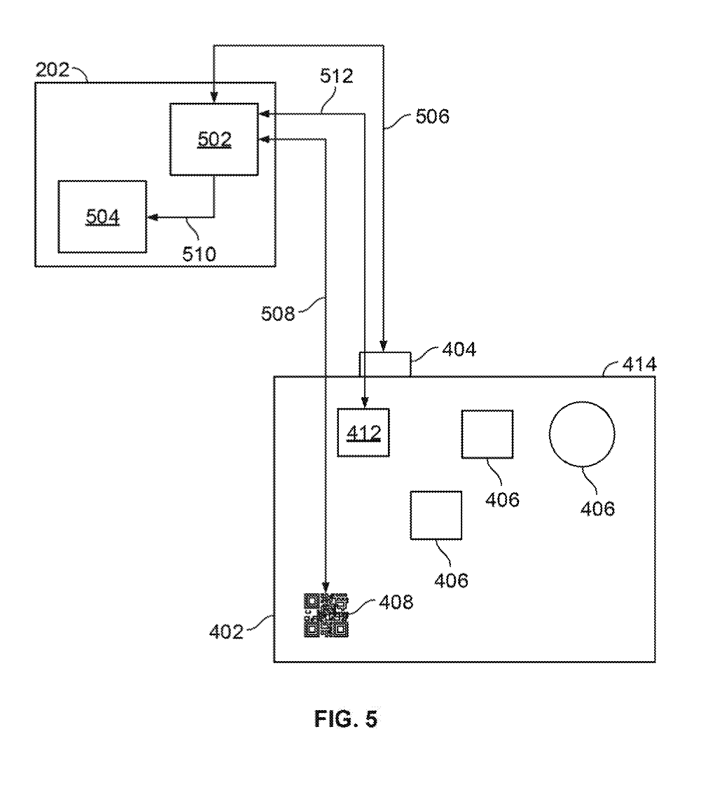

The interaction between training console 414 and virtual reality goggles 202 will be further described with reference to FIGS. 3 and 5.

Returning to FIG. 3, the position of a tagging element is detected (S306). This will be further described with additional reference to FIG. 5.

FIG. 5 illustrates a training system in accordance with aspects of the present invention.

As shown in the figure, virtual reality system 202 includes a tracking system 502 and an imaging system 504. Tracking system 502 communicates with imaging system 504 via communication channel 510. Tagging element 404 communicates with tracking system 502 via communication channel 506, tagging element 412 communicates with tracking system 502 via communication channel 512, and verification element 408 communicates with tracking system 502 via communication channel 508.

Tracking system 502 may be any known device or system that can sense the position and/or orientation of a target object and output information to imaging system 504 based on the position and/or orientation of the target object. Non-limiting examples of tracking system 502 include an optical detection system, an EM/RF detection system, a magnetic detection system, an acoustic detection system and combinations thereof. A target object, or object, as discussed herein, is a real three dimensional object that will be imaged as a virtual three dimensional object.

Imaging system 504 may be any device or system that can receive information regarding the position and/or orientation of a target object and create a visual display based on the information. Non-limiting examples of imaging system 504 include augmented reality imaging systems and virtual reality imaging systems. An augmented reality imaging system is a system in which a real-world image is augmented (or supplemented) by computer-generated graphics. A virtual reality imaging system is a system in which a computer-generated simulation of a three-dimensional image or environment can be interacted with in a seemingly real or physical way by a person. Either system may include eyewear or a helmet for projecting the computer-generated image to the eye of the user, for example via a head-up display.

For purposes of discussion, consider the situation in which trainee 106 is beginning a training program. In this example, to begin training, trainee 106 sits down in front of training console 414, which in this example is the target object. In alternate embodiments, trainee 106 may train on training console 402 or 410, but for purposes of explanation only a training session with training console 414 will be described in detail. Trainee 106 then dons virtual reality goggles 202 to initiate the training session.

For the training session to be successful, virtual reality goggles 202 must accurately display to trainee 106 a virtual image of training console 414 and console controls 406 that corresponds to the physical location of training console 414 and console controls 406. To do so, tracking system 502 first locates and scans verification element 408.

The information provided by verification element 408 to tracking system 502 is based on the type of training console on which trainee 106 is being trained. For example, verification element 408 may provide notification that training console 414 is a training console for a landing signal officer. Information linking verification element 408 to a landing signal officer training console is programmed in to virtual reality system 504 prior to beginning the training session. In other non-limiting embodiments, other verification elements may provide notification that the training console is for a fighter jet, a submarine, or an air traffic control center. In further non-limiting embodiments, other verification elements may provide notification that the training console is for non-military applications such as cash register operation, inputting customer orders, or operating machinery in a manufacturing facility.

Next, tracking system 502 locates a tagging element that provides a signal to tracking system 502 such that tracking system 502 can determine the position and/or orientation of training console 414. In this example, tracking system 502 detects tagging element 404 and tagging element 412.

In some embodiments, tagging element 404 may provide tracking system 502 with the position of training console 414 via communication channel 506 and tagging element 412 may provide tracking system 502 with the orientation of training console 414 via communication channel 512. In other embodiments, a training console may be equipped with a single tagging element to provide the position and/or the orientation of the training console. In still other embodiments, a training console may be equipped with more than two tagging elements to provide multiple reference points for position and/or orientation of the training console and/or the position and orientation of the console controls 406.

Returning to FIG. 3, the tagging element signal is outputted (S308). This will be further described with additional reference to FIG. 5.

As shown in the figure, after tracking system 502 receives information from verification element 408 and tagging elements 404 and 412, tracking system 502 uses that information to create signals based on that information. For example, tracking system 502 generates a verification signal based on the type of training console on which trainee 106 is being trained. Tracking system 502 also generates a tagging element signal based on the position of tagging element 404, and tracking system 502 generates another tagging element signal based on the orientation of tagging element 412. The signals generated by tracking system 502 are then outputted to imaging system 504 via communication channel 510.

Returning to FIG. 3, the image of the 3-D object is generated (S310). This will be further described with additional reference to FIG. 5.

As shown in the figure, imaging system 504 receives a verification signal and one or more tagging signals from tracking system 502 via communication channel 510. Using the information contained in the verification signal, imaging system 504 is able to generate an image of the appropriate training console to display to trainee 106. Without additional information, though, imaging system 504 may not know where to place and/or orient the training console on the image it is going to display to trainee 106.

In accordance with one aspect of the invention, to properly position the training console on the image, imaging system 504 uses the information contained in the tagging signals received from tagging elements 404 and 412. In this example, tagging element 404 provides information regarding the location of training console 414. Using this information, imaging system 504 can place the image of the training console in the correct location on the image it is going to display to trainee 106. Tagging element 412 provides information regarding the orientation of training console 414. Using this information, imaging system 504 can properly orient the image of the training console on the image it is going to display to trainee 106. With the image of the appropriate training console properly positioned and oriented, trainee 106 will have a valuable training experience.

Returning to FIG. 3, the entire image is generated (S312). This will be further described with additional reference to FIG. 5.

As shown in the figure, imaging system 504 receives signals from tracking system 502 via communication channel 510. Included in the information contained in the verification signal is information regarding the environment in which the training console is located. For example, if trainee 106 is supposed to train as a landing signal officer, the training console will be located on a virtual representation of an aircraft carrier. Or, if trainee 106 is supposed to train as a submarine navigator, the training console will be located in a virtual representation of a submarine. To make for a more immersive training experience it is important that the environment surrounding the console be similar to the environment in which trainee 106 will eventually be working. Therefore, imaging system 504 uses the additional information contained in the verification signal to create additional images around the training console to make trainee 106 feel as though the training is taking place in the correct environment.

Returning to FIG. 3, method 300 ends (S314).

At this point, trainee 106 is ready to begin the training session. Throughout the training session, trainee 106 may need to manipulate buttons to perform certain operations. Because trainee 106 is wearing virtual reality goggles 202, trainee 106 sees a surrounding virtual environment that simulates a real environment. To manipulate buttons on the virtual training console, trainee 106 moves his fingers to touch the virtual buttons he sees through virtual reality goggles 202. When trainee 106 presses a virtual button, his hand will contact console controls 406 on training console 414 to provide trainee 106 haptic feedback to verify the appropriate button has been pressed. If appropriate, the virtual image will change to reflect the new position/state of the button, knob, lever, etc.—which means that a “button” may have its own tracker.

At different points during the training session, trainee 106 may need to move around the virtual training console. Because imaging system 504 has generated images around the virtual training console, the virtual environment remains seamless as trainee 106 changes position. In addition, as trainee 106 moves around or changes position, tracking system 502 provides updated signals to imaging system 504 regarding the location and orientation of training console 414 based on tagging elements 404 and 412. Imaging system 504 is then able to modify the virtual image of the training console so the virtual position and orientation of the training console matches that of training console 414. As a result, trainee 106 does not experience issues related to ghost images of buttons as described above.

The system and method described above provide flexibility for training on various types of devices. Because the training environment is a computer generated environment based on a real-life environment, many different types of training environments can be loaded on to virtual reality system 504 and displayed via goggles 202. When tracking system 502 reads the verification element on the training console, imaging system 504 will display the programmed environment associated with the verification element. Therefore, virtual reality goggles may be used to train a trainee as a landing signal officer in a first training session, and then as a submarine commander in a second training session, and then as an air traffic controller in a third training session, with the only difference in the sessions being the physical training console on which the virtual environment is based, and the corresponding 3-D models in the virtual environment. Virtual reality system 504 will distinguish between the environments to display based on the verification elements on the different training consoles, with imaging system 504 displaying the appropriate images to the trainee via virtual reality goggles 202.

Additionally, the system is useful because any changes or updates to actual consoles can be addressed quickly. For example, the button configuration on an actual console may be modified, rendering training consoles based on the actual console irrelevant. An updated training console may be created quickly via 3-D printing, and the new configuration may be uploaded to virtual reality system 504 quickly by a simple software update. In a relatively short period of time, and for a low cost, training can commence based on the new configuration.

In summary, conventional methods of providing training require the trainers to create fully functioning replicas of the actual systems, which can be very expensive. In addition, when there are changes to the actual systems, the training replicas must change as well, creating additional costs. Furthermore, when a trainee uses a virtual reality headset in tandem with the training replica, oftentimes there are haptic feedback issues when the trainee perceives a button to be in a certain area of virtual space, but the real counterpart to the virtual button is not where the trainee is attempting to push. These types of ghosting issues make for a suboptimal training environment.

The present invention provides an adaptable system and method to train individuals in a cost effective manner. One or more electronic files detailing images of the actual console and the surrounding environment are loaded onto a virtual reality system. A replica training console is created by 3-D printing or other methods, and the replica includes a verification element and one or more tagging elements. The virtual reality system communicates with the verification element to determine which of the uploaded images should be presented virtually to the trainee to correspond to the replica console on which he will train. The virtual reality system also communicates with the one or more tagging elements to determine the location and/or orientation of the replica console to accurately show the trainee the virtual images of the actual console corresponding to the location and/or orientation of the replica console.

The present invention provides for fast updates to the virtual reality system when actual consoles are changed or updated, and it also provides for fast updates to the replica consoles because replica consoles can be created quickly via 3-D printing. In addition, the present invention is more economically feasible than creating fully functioning replicas of the consoles and the environments in which they are used.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A system comprising:
a three dimensional object;
a tagging element disposed at a tagging element position of said three dimensional object so as to correspond with an object position of said three dimensional object;
a tracking system operable to detect the tagging element position and to output a tagging element detected signal based on the detected tagging element position; and
an imaging system operable to generate an object image based on the tagging element detected signal,
wherein the object image corresponds to said three dimensional object at a generated object position corresponding to the object position.

2. The system of claim 1, further comprising:
a second tagging element disposed at a second tagging element position of said three dimensional object,
wherein said tracking system is further operable to detect the second tagging element position and to output a second tagging element detected signal based on the detected second tagging element position, and
wherein said imaging system is further operable to generate the object image additionally based on the second tagging element detected signal.

3. The system of claim 2, wherein said tracking system comprises one of the group consisting of an optical detection system, an EM/RF detection system, a magnetic detection system, an acoustic detection system and combinations thereof.

4. The system of claim 3, wherein said imaging system comprises one of the group consisting of a virtual reality imaging system and an augmented reality imaging system.

5. The system of claim 2, wherein said imaging system comprises one of the group consisting of a virtual reality imaging system and an augmented reality imaging system.

6. The system of claim 1,
wherein said tagging element is additionally disposed with a tagging element orientation so as to correspond with an object orientation of said three dimensional object,
wherein said tracking system is further operable to detect the tagging element orientation and to output the tagging element detected signal additionally based on the detected tagging element orientation, and
wherein the object image additionally corresponds to said three dimensional object at a generated object orientation corresponding to the object orientation.

7. The system of claim 6, wherein said tracking system comprises one of the group consisting of an optical detection system, an EM/RF detection system, a magnetic detection system, an acoustic detection system and combinations thereof.

8. The system of claim 7, wherein said imaging system comprises one of the group consisting of a virtual reality imaging system and an augmented reality imaging system.

9. The system of claim 6, wherein said imaging system comprises one of the group consisting of a virtual reality imaging system and an augmented reality imaging system.

10. A method of displaying an image, said method comprising:
creating a three dimensional object having a tagging element disposed therein at a tagging element position of the three dimensional object so as to correspond with an object position of the three dimensional object;
detecting, via a tracking system, the tagging element position;
outputting, via the tracking system, a tagging element detected signal based on the detected tagging element position; and
generating, via an imaging system, an object image based on the tagging element detected signal,
wherein the object image corresponds to the three dimensional object at a generated object position corresponding to the object position.

11. The method of claim 10, wherein said creating the three dimensional object further comprises creating the three dimensional object additionally having a second tagging element disposed therein at a second tagging element position of the three dimensional object.

12. The method of claim 11, further comprising:
detecting, via the tracking system, the second tagging element position; and
outputting, via the tracking system, a second tagging element detected signal based on the detected second tagging element position, and
wherein said generating, via the imaging system, an object image based on the tagging element detected signal comprises generating the object image additionally based on the second tagging element detected signal.

13. The method of claim 12, wherein detecting, via the tracking system, the tagging element position comprises detecting the tagging element position via one of the group consisting of an optical detection system, an EM/RF detection system, a magnetic detection system, an acoustic detection system and combinations thereof.

14. The method of claim 13, wherein said generating, via the imaging system, an object image based on the tagging element detected signal comprises generating the object image via one of the group consisting of a virtual reality imaging system and an augmented reality imaging system.

15. The method of claim 11, wherein said generating, via the imaging system, an object image based on the tagging element detected signal comprises generating the object image via one of the group consisting of a virtual reality imaging system and an augmented reality imaging system.

16. The method of claim 10, wherein said creating the three dimensional object comprises creating the three dimensional object such that the tagging element is additionally disposed with a tagging element orientation so as to correspond with an object orientation of the three dimensional object.

17. The method of claim 10, further comprising:
detecting, via the tracking system, the tagging element orientation,
wherein said outputting, via the tracking system, the tagging element detected signal further comprises outputting the tagging element detected signal additionally based on the detected tagging element orientation, and
wherein the object image additionally corresponds to the three dimensional object at a generated object orientation corresponding to the object orientation.

18. The method of claim 17, wherein detecting, via the tracking system, the tagging element position comprises detecting the tagging element position via one of the group consisting of an optical detection system, an EM/RF detection system, a magnetic detection system, an acoustic detection system and combinations thereof.

19. The method of claim 18, wherein said generating, via the imaging system, an object image based on the tagging element detected signal comprises generating the object image via one of the group consisting of a virtual reality imaging system and an augmented reality imaging system.

20. A method of displaying an image, said method comprising:
creating a three dimensional object having a tagging element disposed therein at a tagging element position of the three dimensional object and with a tagging element orientation so as to correspond with an object position and an object orientation of the three dimensional object;
detecting, via a tracking system, the tagging element position and the tagging element orientation;
outputting, via the tracking system, a tagging element detected signal based on the detected tagging element position and the tagging element orientation; and
generating, via an imaging system, an object image based on the tagging element detected signal,
wherein the object image corresponds to the three dimensional object at a generated object position corresponding to the object position and at a generated object orientation corresponding to the object orientation, and
wherein said generating, via the imaging system, an object image based on the tagging element detected signal comprises generating the object image via one of the group consisting of a virtual reality imaging system and an augmented reality imaging system.
